(19) United States
(12) Patent Application Publication
(10) Pub. No.: US 2016/0010468 A1
(43) Pub. Date: Jan. 14, 2016

(54) COMPOSITE AIRFOIL METAL LEADING EDGE ASSEMBLY

(71) Applicant: GENERAL ELECTRIC COMPANY, Schenectady, NY (US)

(72) Inventors: Nicholas Joseph KRAY, Mason, OH (US); Qiang LI, Cincinnati, OH (US); Richard W. ALBRECHT, JR., Cincinnati, OH (US)

(73) Assignee: GENERAL ELECTRIC COMPANY, Schenectady, NY (US)

(21) Appl. No.: 14/771,970

(22) PCT Filed: Mar. 1, 2013
(86) PCT No.: PCT/US13/28661

§ 371 Date: Sep. 1, 2015

(51) Int. Cl. F01D 5/28; F01D 5/14; F01D 9/04

(52) U.S. Cl. CPC F01D 5/28; F01D 9/041; F01D 5/147; F05D 2220/32; F05D 2230/23; F05D 2230/60; F05D 2300/133; F05D 2300/171; F05D 2300/174

(57) ABSTRACT

An airfoil assembly (30) comprises a composite airfoil (40) having a leading edge (32) and a trailing edge (34), a pressure side (36) extending between the leading edge and the trailing edge, a suction side (38) extending between the leading edge and the trailing edge, opposite the leading edge, a metallic leading edge assembly (130) disposed over the composite air-foil, the metallic leading edge assembly including a high density base (50), the metallic leading edge assembly also including a nose (60) disposed over the base, an adhesive bond layer disposed between the composite airfoil and the metallic leading edge assembly.

### BACKGROUND

Present embodiments relate generally to gas turbine engines. More specifically, but not by way of limitation, present embodiments relate to composite airfoils having a metal leading edge assembly to enhance impact capability of composite blades.

A typical gas turbine engine generally possesses a forward end and an aft end with its several core or propulsion components positioned axially there between. An air inlet or intake is located at a forward end of the engine. Moving toward the aft end, in order, the intake is followed by a compressor, a combustion chamber, and a turbine. It will be readily apparent from those skilled in the art that additional components may also be included in the engine, such as, for example, low-pressure and high-pressure compressors, and low-pressure and high-pressure turbines. This, however, is not an exhaustive list.

The compressor and turbine generally include rows of airfoils that are stacked axially in stages. Each stage includes a row of circumferentially spaced stator vanes and a row of rotor blades which rotate about a center shaft or axis of the turbine engine. The turbine engine may include a number of stages of static air foils, commonly referred to as vanes, interspaced in the engine axial direction between rotating air foils commonly referred to as blades. A multi-stage low pressure turbine follows the two stage high pressure turbine and is typically joined by a second shaft to a fan disposed upstream from the compressor in a typical turbo fan aircraft engine configuration for powering an aircraft in flight.

An engine also typically has an internal shaft axially disposed along a center longitudinal axis of the engine. The internal shaft is connected to both the turbine and the air compressor, such that the turbine provides a rotational input to the air compressor to drive the compressor blades. The first and second rotor disks are joined to the compressor by a corresponding rotor shaft for powering the compressor during operation.

In operation, air is pressurized in a compressor and mixed with fuel in a combustor for generating hot combustion gases which flow downstream through turbine stages. The turbine stages extract energy from the combustion gases. A high pressure turbine first receives the hot combustion gases from the combustor and includes a stator nozzle assembly directing the combustion gases downstream through a row of high pressure turbine rotor blades extending radially outwardly from a supporting rotor disk. The stator nozzles turn the hot combustion gas in a manner to maximize extraction at the adjacent downstream turbine blades. In a two stage turbine, a second stage stator nozzle assembly is positioned downstream of the first stage blades followed in turn by a row of second stage rotor blades extending radially outwardly from a second supporting rotor disk. The turbine converts the combustion gas energy to mechanical energy.

Due to extreme temperatures of the combustion gas flow path and operating parameters, the stator vanes and rotating blades in both the turbine and compressor may become highly stressed with extreme mechanical and thermal loading.

One known means for increasing performance of a turbine engine is to increase the operating temperature of the engine, which allows for hotter combustion gas and increased extraction of energy. Additionally, foreign objects occasionally pass by these components with airflow. However a competing goal of gas turbine engines is to improve performance through weight reduction of components in the engine. One means of reducing weight of engine components is to reduce weight through the use of composite materials. Such composites however are generally more prone to damage from foreign objects passing through the airfoil area and are more susceptible to damage from higher operating temperatures.

As may be seen by the foregoing, it would be desirable to overcome these and other deficiencies with gas turbine engines components. More specifically, it would be desirable to overcome these deficiencies to improve impact capabilities of composite airfoils which may be utilized at various locations throughout a gas turbine engine.

### BRIEF SUMMARY OF THE INVENTION

According to aspects of the present embodiments, a metal leading edge assembly is applied to a composite airfoil. The composite airfoil may be utilized at various locations within the gas turbine engine. The metal leading edge assembly improves erosion and impact characteristics of the composite foil while allowing for the lighter weight composite material to be utilized.

According to some aspects of the instant embodiments an airfoil assembly comprises a composite foil having a leading edge and a trailing edge, a pressure side extending between the leading edge and he trailing edge, a suction side extending between the leading edge and the trailing edge, opposite the leading edge, a metallic leading edge assembly disposed over the composite blade, the metallic leading edge assembly including a high density base, the metallic leading edge assembly also including a nose disposed over the base, an adhesive bond layer disposed between the composite blade and the metallic leading edge assembly. The nose may be a solid insert. The airfoil assembly wherein said airfoil is one of a fan blade, a turbine blade, a compressor blade or a vane. The airfoil assembly wherein the high density base is formed of a uniform thickness or a varying thickness. The base may be welded to the nose or adhesively bonded to the nose. The base may have first and second legs which are longer than side walls of the nose. The airfoil assembly wherein the metal leading edge assembly may be formed of a single construction in a radial direction or may be formed of multiple segments in a radial direction. The airfoil assembly wherein the metal leading edge assembly is a multi-material construction or a single material construction. The metal leading edge assembly may be formed of at least one of Titanium, Steel, Inconel or alloy thereof.

All of the above outlined features are to be understood as exemplary only and many more features and objectives of the invention may be gleaned from the disclosure herein. Therefore, no limiting interpretation of this summary is to be understood without further reading of the entire specification, claims, and drawings included herewith.

### BRIEF DESCRIPTION OF THE DRAWINGS

The above-mentioned and other features and advantages of these exemplary embodiments, and the manner of attaining them, will become more apparent and the composite metal airfoil with metal leading edge insert will be better understood by reference to the following description of embodiments taken in conjunction with the accompanying drawings, wherein:

FIG. 1 is a schematic side section view of a gas turbine engine for an aircraft.

FIG. 2 is an isometric view of an exemplary airfoil with metal leading edge.

FIG. 3 is an assembly view of a metal leading edge section.

FIG. 4 is a section view of an exemplary airfoil with metal leading edge assembly.

FIG. 5 is a first alternative embodiment of an exemplary airfoil with metal leading edge.

FIG. 6 is a second alternative embodiment of an exemplary airfoil with metal leading edge.

FIG. 7 is a third alternative embodiment of an exemplary airfoil with metal leading edge.

FIG. 8 is an exemplary nozzle segment with vanes to which the metallic leading edge assembly may be applied.

FIG. 9 is an exemplary turbine blade and rotor disc assembly.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

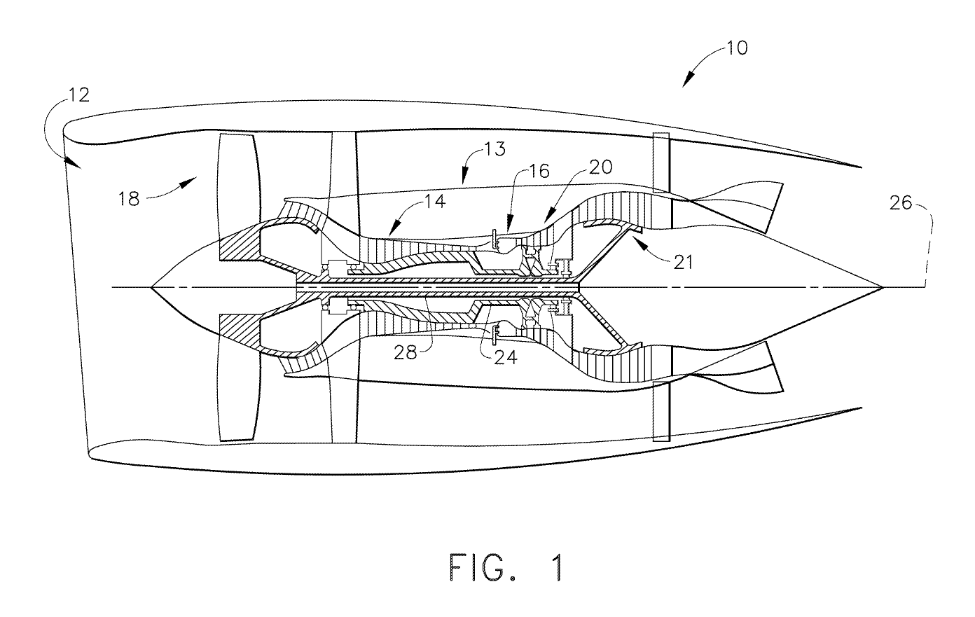

Referring to FIGS. 1-9 various embodiments of composite airfoils are depicted having a metal leading edge insert assembly. The composite airfoil may be utilized at various locations of a gas turbine engine including, but not limited to, a fan, a compressor and a turbine, both blades and vanes. The metal leading edge assembly allows for light weight composite use to construct the airfoil while improving erosion and impact capabilities of the airfoil.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine nozzle, or a component being relatively closer to the engine nozzle as compared to another component.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component. As used herein, the terms “lateral” or “laterally” refer to a dimension that is perpendicular to both the axial and radial dimensions.

Referring initially to FIG. 1, a schematic side section view of a gas turbine engine 10 is shown. The function of the turbine is to extract energy from high pressure and temperature combustion gases and convert the energy into mechanical energy for work. The turbine 10 has an engine inlet end 12 wherein air enters the core or propulsor 13 which is defined generally by a compressor 14, a combustor 16 and a multi-stage high pressure turbine 20. Collectively, the propulsor 13 provides thrust or power during operation. The gas turbine 10 may be used for aviation, power generation, industrial, marine or the like.

In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of the shaft 24. The shaft 24 passes toward the front of the engine to continue rotation of the one or more compressor stages 14, a turbofan 18 or inlet fan blades, depending on the turbine design. The turbofan 18 is connected by the shaft 28 to a low pressure turbine 21 and creates thrust for the turbine engine 10. A low pressure turbine 21 may also be utilized to extract further energy and power additional compressor stages. The low pressure air may be used to aid in cooling components of the engine as well.

The airfoil assemblies 30 may be adapted for use at various locations of the engine 10 (FIG. 1). For example, the assembly 30 may be utilized at the fan 18. The assembly 30 may be used within the compressor 14. Further, the assembly 30 may be utilized within the turbine 20. Moreover, the assembly 30 may be utilized with stationary vanes or moving blades, either of which have airfoil shaped components.

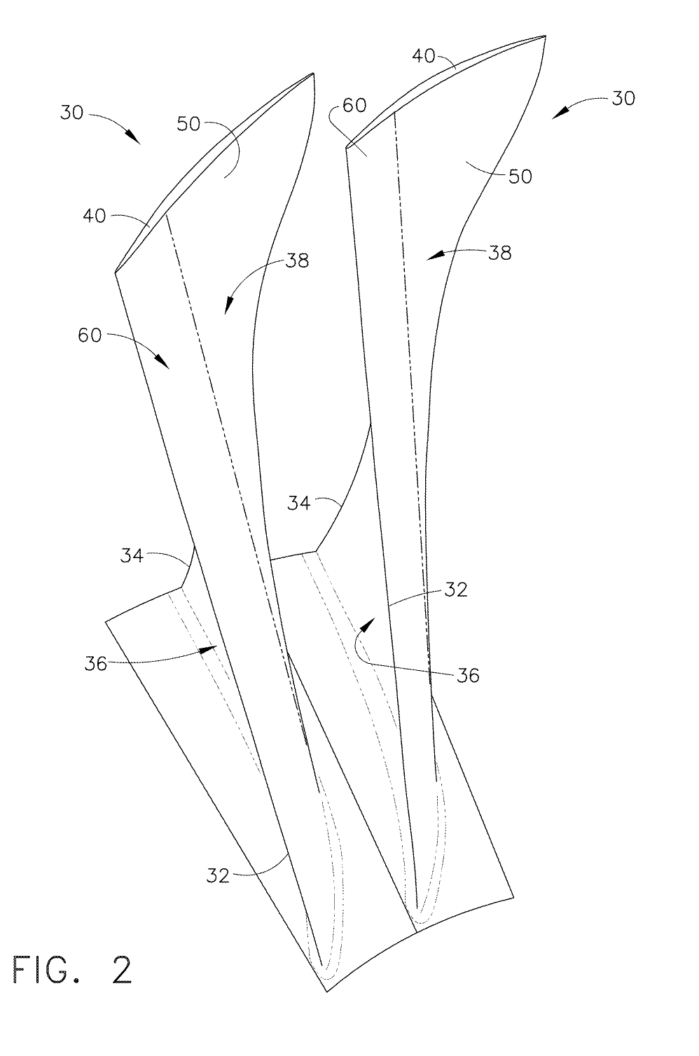

Referring now to FIG. 2, an isometric view of exemplary airfoil assemblies 30 is depicted. The airfoil assemblies 30 are defined by a base 50 and a nose 60 to cover the composite foil 40. According to the instant embodiment, the composite foil 40 may be a blade for use with a fan, compressor or turbine. The airfoil 40 includes a leading edge 32 which air flow first engages and an opposite trailing edge 34. The leading edge 32 and trailing edge 34 are joined by opposed sides of the airfoil 40. On a first side of the airfoil 40 is a pressure side 36 where higher pressure develops. Opposite the pressure side 36 is a suction side 38 extending from the leading edge to the trailing edge 34 as well. The suction side of the airfoil 40 is longer than the pressure side and, as a result, air or combustion gas flow has to move faster over this surface 38 than the surface defining the pressure side 36. As a result, lower pressure is created on the suction side and higher pressure is created on the pressure side 36.

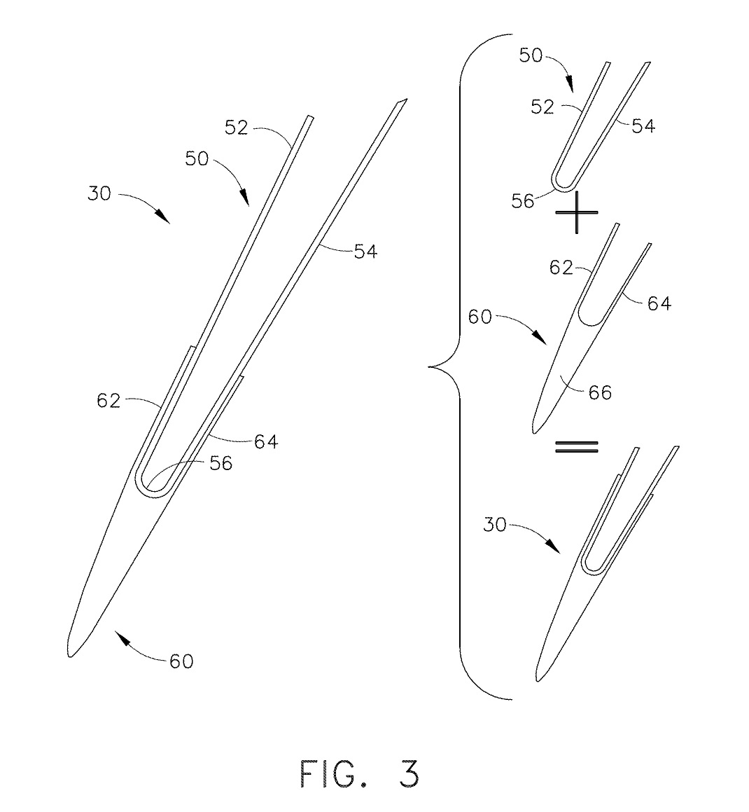

Referring now to FIG. 3, an assembly view of the airfoil assembly 30 is depicted with the composite foil 40 (FIG. 2) removed. According to this embodiment, the assembly 30 is positioned over the composite foil 40. The assembly 30 improves impact resistance of the composite foil 40.

The airfoil assembly 30 defines a metal leading edge assembly defined by the base 50 and the nose 60. In the instant embodiment, the nose 60 is positioned over the base 50. The base 50 includes a first leg 52 and a second leg 54, wherein the leg 52 extends over the pressure side 36 of the composite foil 40 and the second leg 54 extends over the suction side 38. The base 50 is adhesively bonded to the foil 40 at the interface between the two surfaces. Suitable adhesives will be known to one skilled in the art. The legs 52, 54 may extend the entire length of the pressure and suction sides 36, 38 according to some embodiments. However, these legs 52, 54 may be shortened in length as to not extend the entire distance but instead, only extend over portions of the surface of the composite foil 40 (FIG. 2) as needed for heat and impact performance. This length of legs 52, 54 may be dependent upon the operating temperature in the area where the foil assembly 30 is located and the likelihood of foreign object damage in that area. For example, in areas forward in the engine 10 (FIG. 1), the base material is likely to be longer along the pressure and suction sides 36, 38 where there may be a higher likelihood of foreign objects.

At corresponding ends of the legs 52, 54 is a curved section 56. The curved section 56 has a radius which is dependent on the profile of the composite foil over which the base 50 is positioned. The airfoil assembly 30 extends over a substantial length of the airfoil 40 and leading edge 32.

The base 50 is formed of a high-density material and may be formed of various sheet metals such as stainless steel, titanium, inconel or other known materials suitable for use in a gas turbine engine environment. As previously indicated, the legs and curved section 52, 54 and 56 may be of constant thickness or may be of variable thickness depending upon the anticipated temperature or foreign object probability along the surface of the composite airfoil 40.

The nose 60 is positioned over the curved section 56 and extends partially along the first and second legs 52, 54. The nose 60 includes a first side wall 62 and a second side wall 64 which correspond to the first leg 52 and second leg 54. Forward of these walls is a tip 66. The tip 66 may be a solid piece of metal from which the walls 62, 64 extend. Alternatively, the tip 66 may be formed of a metallic extruded or cast insert. As an additional alternative, the tip 66 may be partially hollow to provide some weight reduction while still providing protection to the composite airfoil 40. The tip 66 has a length in the axial direction which allows for some wear of the metal during operation of the engine and engagement of the metallic leading edge assembly 30 by foreign objects or debris passing in the airflow by the composite airfoil 40. The inside of the nose tip 66 has a curved section 68 corresponding to the curved section 56 of the base 50. The side walls 62, 64 may be of constant or varying thickness. In an embodiment, the nose 60 may be formed of various metallic materials, matching the material of the base 50.

Referring still to FIG. 3, the metal leading edge assembly 30 is also shown assembled from the separate base 50 and nose 60 components. The nose 60 may be welded to the base 50 or alternatively adhesively bonded. Additionally, combinations of weld and adhesive may be used to connect the base 50 and nose 60 to the composite foil 40 at an interface between the two. The walls 62, 64 and the legs 52, 54 provide large surface areas for adhesive, welding or otherwise bonding the parts together.

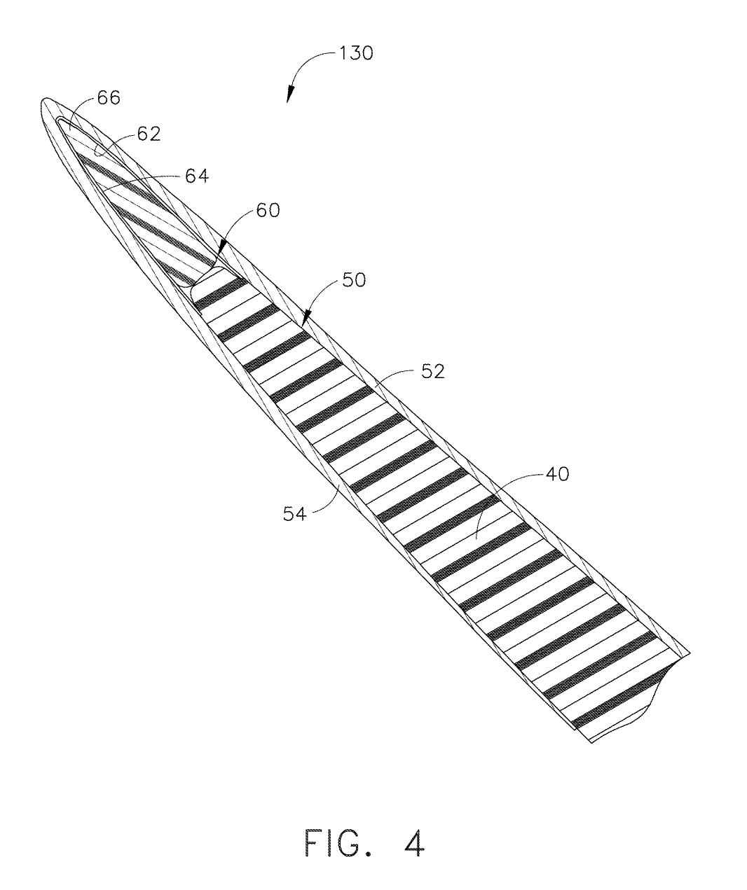

Referring now to FIG. 4, the side section view of the composite airfoil 40 and the metallic leading edge assembly 130 is depicted. The assembly 130 comprises the base 50 and the nose 60. Alternative to FIG. 3, the base 50 is positioned over the nose 60 and the assembly 130 is adhesively bonded to the foil 40. Such adhesives will be understood to one skilled in the art. The assembly 130 is positioned over the composite airfoil 40 to protect the composite material from damage by foreign objects and to provide some shielding from heat of the high temperature and pressure gases moving through the gas turbine engine 10 (FIG. 1). The nose tip 66 is shown as a solid material with a hatch pattern and is surrounded by the walls 62, 64. The tip may alternatively be extruded or cast insert bonded to walls 62, 64. The opposite ends of the walls 62, 64 extend to the composite airfoil 40 and may be bonded, affixed or otherwise connected to the composite material of the airfoil 40. The tip 66 is shown as a solid material but may be partially hollowed if desirable to reduce weight. Additionally, the base 50 is shown with legs 52, 54 of varying thickness over the length of the airfoil 40. The legs 52, 54 may be a constant thickness. Further, the side walls 62, 64 may be constant or varying thickness.

Referring now to FIG. 5, a second alternative embodiment of the metallic leading edge assembly 230 is depicted. In this embodiment, the assembly 230 is formed of a single radial length extending over the desired length of the composite airfoil 40. Any of the assemblies described may extend linearly in a radial direction, may be curved along the radial length and may or may not be twisted along the radial length. Additionally, the nose 60 is disposed on the outside of the base 50.

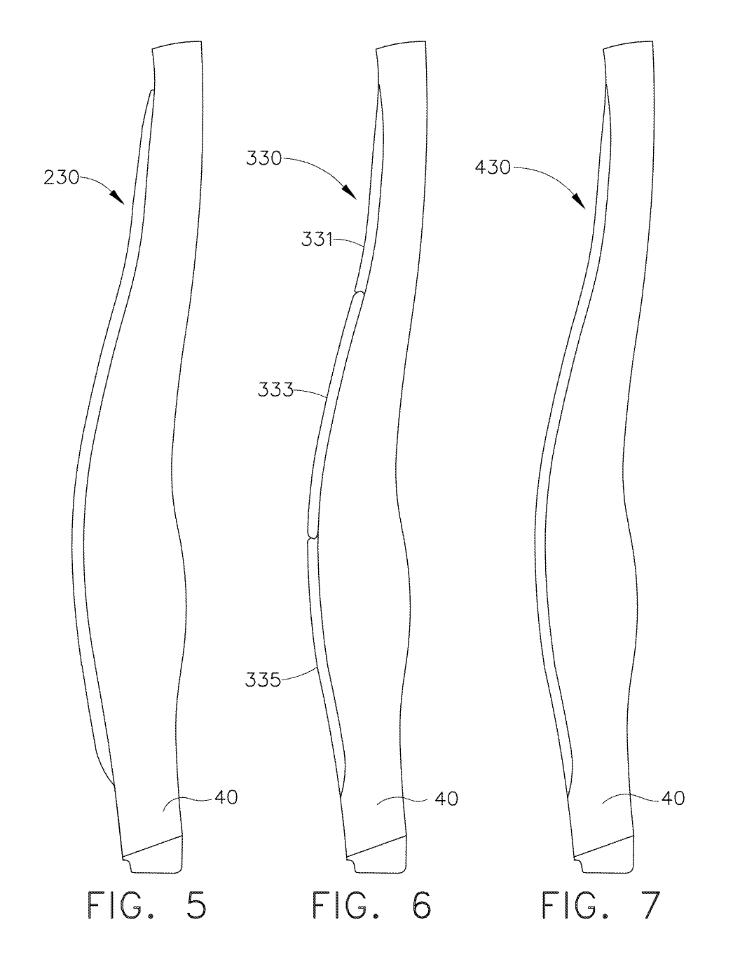

With reference to FIG. 6, the metallic leading edge 330 is formed of at least two segments 331, 333. According to the depicted embodiment, a third segment 335 is utilized to extend across the desired length of the composite airfoil 40. It should be understood by comparison of FIG. 5 and FIG. 6 that the base may be a single piece or formed in segments and that the nose may also be of a single piece or formed in segments extending radially. Additionally, the combination of structures may be formed in segments or as a continuous structure as shown so that seams of one or both of the base 50 or nose 60 overlap. In this embodiment, the nose 60 may be placed on the outside of the base 50 or interior to the base 50.

With reference to FIG. 7, an embodiment is depicted which shows an embodiment of the metal leading edge assembly wherein the nose 60 is disposed on the interior of the base 50. This is opposite the embodiment of FIG. 5 wherein the nose is disposed on the outside of the base.

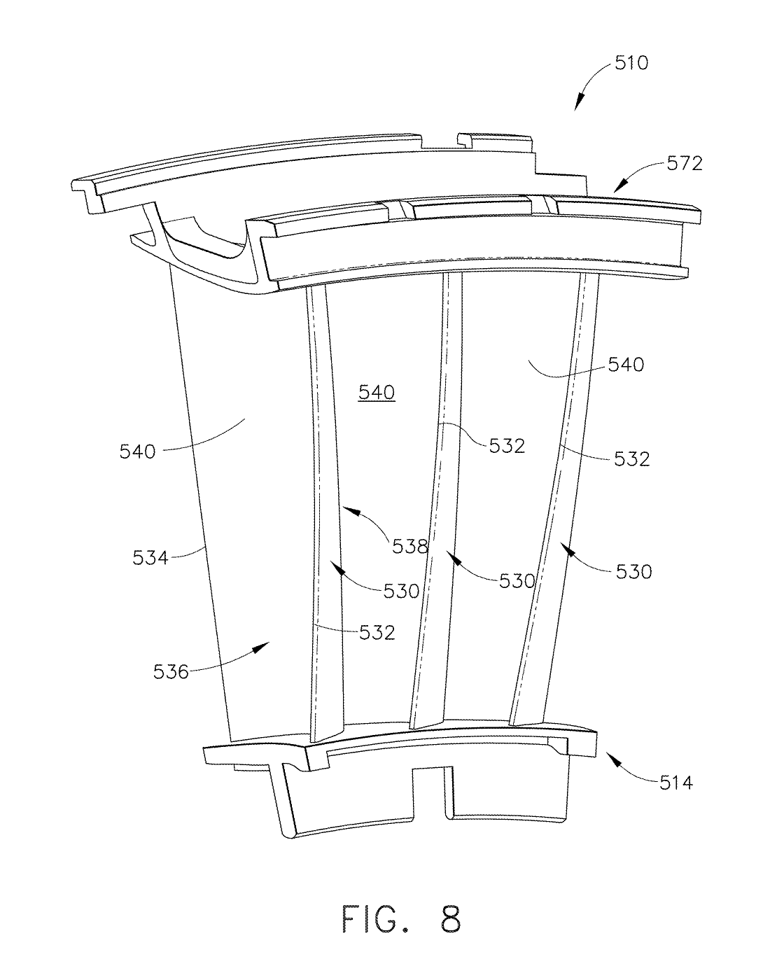

With reference to FIG. 8, an exemplary nozzle segment 510 is shown. The metallic leading edge assembly 530 or any of the alternatives previously described may be utilized with vanes 540 of a nozzle segment 510. Turbine nozzle assemblies are defined by a plurality of segments 510 which are circumferentially coupled together to form the circumferential assembly. Nozzle segments 510 typically include a plurality of circumferentially spaced airfoil vanes 540 coupled together by an arcuate radially outer band or platform 512 and an opposing arcuate radially inner band or platform 514. Generally, these segments may include two airfoil vanes 540 per segment in an arrangement generally referred to as a doublet. In alternative embodiments, a nozzle segment may include a single airfoil vane, which is generally referred to as a singlet. In further alternatives, multiple vanes, more than two vanes, may be included on a segment. The embodiments of the metal leading edge assembly 530 may be utilized with nozzle designs according to the various embodiments described herein.

The airfoil 140 may be solid internally, as shown in FIG. 4, or may be partially hollowed with partitions to direct cooling air. According to other embodiments, a turbine or compressor vane 540 comprises a pressure side 536 and a laterally opposite suction side 538 wherein the pressure side is generally concave and the suction side is generally convex, a trailing edge 534 defined at one location where the suction side and the pressure side join, a leading edge 532 at a second location where the suction side and the pressure side join. Internally, in the case of nozzle vane structures, the airfoil 40 may include one or more partitions extending between the pressure and suction sides 536, 538 and forming internal cavities. The airfoil 140 may include a nozzle inlet at the inner band 514 to allow air flow into the internal cavities which protects the interior of foil 540.

The vanes may further comprises a plurality of rows of cooling apertures to allow cooling air to move from the interior to the exterior pressure side 536 and leading edge 532 to provide cooling film along the surface of the airfoil 540. Apertures may also be disposed along the suction side 538. Additionally, the trailing edge 534 also includes cooling apertures. These cooling apertures may be utilized to establish a cooling film inhibiting damage to the airfoil 40 from the high temperature combustion gas.

The composite foil 40 defining, for example, the above described nozzle vane may be covered along at least one of the pressure side and suction side 36, 38 with a base 50. This may be formed of a metallic sheet material and may be of constant thickness or variable thickness. Toward the leading edge 32, a nose 60 is positioned over the base 50. However, the nose structure according to the instant embodiments does not extend the full surface length of the composite foil 40. Alternatively however, it is within the scope of the disclosure that the assembly 30 may extend over the entire leading edge of a foil. It should be understood by one skilled in the art that any of the previously described embodiments may be utilized with any of the foil shapes used for the fan section, compressor section and turbine section.

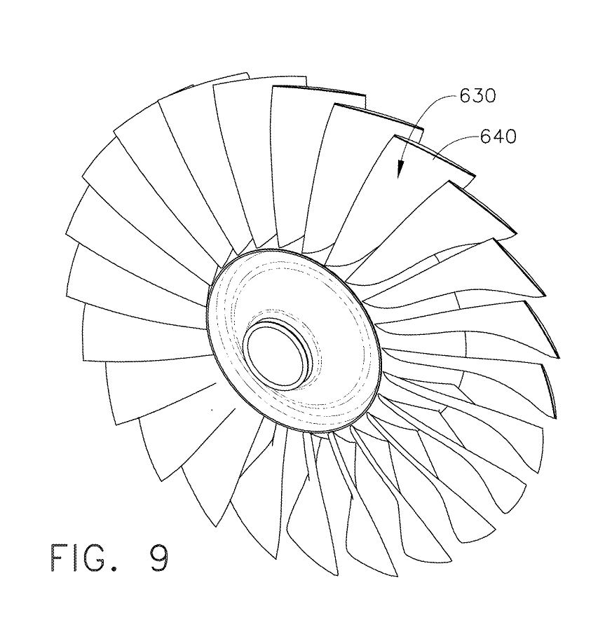

In a final embodiment of FIG. 9, the metal leading edge assembly 610 may be utilized in a turbine blade 640. The figure shows a plurality of lower pressure turbine blades arranged on a rotor disc. It should be understood from the instant disclosure that the MLE assembly may be utilized with turbine blades, compressor blades, fan blades or stator blades of compressors or turbines.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An airfoil assembly, comprising:
a composite foil having:
a leading edge and a trailing edge;
a pressure side extending between said leading edge and said trailing edge;
a suction side extending between said leading edge and said trailing edge, opposite said leading edge;
a metallic leading edge assembly disposed over said composite foil;
said metallic leading edge assembly including a high density base;
said metallic leading edge assembly also including a nose disposed one of over or under said base;
an adhesive bond layer disposed between the composite foil and the metallic leading edge assembly.

2. The airfoil assembly of claim 1, wherein said high density base is formed of a uniform thickness.

3. The airfoil assembly of claim 1, wherein said high density base is formed of a varying thickness.

4. The airfoil assembly of claim 1, said base being welded to said nose.

5. The airfoil assembly of claim 1, said base being bonded to said nose.

6. The airfoil of claim 1, said base having first and second legs which are longer than side walls of said nose.

7. The airfoil of claim 1, wherein said metal leading edge assembly is formed of a single construction in a radial direction.

8. The airfoil of claim 1, wherein said metal leading edge assembly is formed of multiple segments in a radial direction.

9. The airfoil of claim 1, wherein said nose is bonded to said composite foil and covered by said base.

10. The airfoil of claim 1, wherein said metal leading edge assembly is a multi-material construction.

11. The airfoil of claim 1, wherein said metal leading edge assembly is a single material construction.

12. The airfoil of claim 1, wherein said wrap is formed of at least one of Titanium, Steel, Inconel or alloy thereof.

13. The airfoil of claim 1, wherein said airfoil is one of a fan blade, a turbine blade, a compressor blade and a vane.

14. An airfoil assembly, comprising:
an airfoil having a leading edge, a trailing edge, a pressure side and a suction side;
said airfoil formed of a first material;
a metallic leading edge (MLE) assembly of a second material having first and second side walls extending over said pressure side, said suction side and said leading edge;
said MLE assembly having a nose portion at a radial outer end of said blade;
said MLE assembly having a base portion disposed beneath said nose portion, said base portion also having said first and second side walls;
said assembly being adhesively bonded to said airfoil.

15. The airfoil assembly of claim 14, said blade being a composite material.

16. The airfoil assembly of claim 14, said MLE assembly being formed of sheet metal.

17. The airfoil assembly of claim 16, said nose being a solid insert.

18. The airfoil assembly of claim 16, said sheet metal being one of constant thickness or tapered thickness.

19. An airfoil assembly for a composite airfoil, comprising:
a metal leading edge assembly including a high-density metallic sheet base having a first leg and a second leg joining at a curved section;
said first and second legs extending over sides of said airfoil;
a metal nose disposed one of over said base or under said base;
said metal leading edge assembly bonded to said composite airfoil.

20. The airfoil assembly of claim 19, said base bonded to said composite airfoil and said nose at least one of welded to said base or bonded to said composite airfoil.
